(19) United States
(12) Patent Application Publication
(10) Pub. No.: US 2005/0023836 A1
(43) Pub. Date: Feb. 3, 2005

(54) Variable buoyancy float engine

(76) Inventor: John A. Abdalla, Richmond, OH (US)

Correspondence Address: WOOD, HERRON & EVANS, LLP, 2700 CAREW TOWER, 441 VINE STREET, CINCINNATI, OH, 45202, US

(21) Appl. No.: 10/628,650

(22) Filed: Jul. 28, 2003

(51) Int. Cl. F03D 9/00

(52) U.S. Cl. 290/44

(57) ABSTRACT

An open and a closed system versions of a float tank actuated hydroelectric generator system is provided for generating work or electrical power. The closed system includes a fluid chamber, a float tank, a drain tank and plug, and a convertor for converting mechanical energy into work or electricity. Additionally, a piston, shaft, and recycling pool may be used. In its closed system form, in one version consistent with the invention, the float tank becomes negatively buoyant by allowing its inner chamber to flood or to become positively buoyant by draining its water ballast. The descent of the float tank pushes the piston into the shaft which force water through a hydroelectric generator. Water discharging from the generator is captured in a recycling pool which refills the shaft when the float tank ascends. The float tank is drained into a drain tank which in turn allows the float tank to ascend. The drain tank is recycled by first allowing it to descend over a plug, thus expelling its fluid back into the fluid chamber. The slidable plug then descends through the drain tank, drawing air back into the tank, whereby the drain tank and plug are enabled to ascend together. A plurality of valves control the flow of air and water in the system.

### BACKGROUND

Hydroelectric power is an efficient, abundant power source, relied upon in many parts of the world. This has led to the development of reliable turbine generators.

However, in many instances constructing additional dams to store the water necessary to power these hydroelectric generators is not practical due to the nature of the water source. For example, the grade of the available terrain may be too shallow to allow a dam of sufficient height to develop the required motive flow for the efficient operation of a hydroelectric turbine. In other situations, there may not be a stream or river to dam. In addition, the ecological impact or economic expense of constructing such a dam may be prohibitive.

In yet a further situation, dammed water may be desired to be transferred to a distant or elevated location. However, the number of electrical pumps needed may consume a considerable amount of energy.

In yet another situation, an existing dam and hydroelectric generator system are available; however, an augmented system is desired for instances during extended droughts or to more fully utilize the power generation capability of the generators.

What is needed is a system that consistently provides stable electrical energy in quantities suitable for addition to the electrical power grid by taking advantage of hydroelectric power generation technology. Furthermore, this system should not require a large dam to create sufficient water pressure for efficient operation of a hydroelectric generator. Alternatively, the water pressure could be used to elevate or transfer water across a distance. Moreover, such a system should be operable in situations where water is a scarce commodity by being capable of implementation as a closed system. Also, the system should be as efficient as possible in converting motive power into electricity.

### SUMMARY

The invention, generally referred to as a hydro engine or variable buoyancy float engine, meets these and other needs. The invention relates to hydroelectric generators, and has special application to a generator which is activated by a fluid flowing through a conduit. By concentrating the weight of a float tank onto a small area, a pressurized stream of fluid is provided making full use of the generator. Recycling the float tank for its next stroke is performed efficiently with a minimum of mechanical parts. In addition, the system is ecologically sound.

In its closed system form, one version consistent with the invention uses a float tank that can become negatively buoyant by allowing its inner chamber to flood or to become positively buoyant by draining its ballast. The descent of the float tank pushes a piston into a shaft to force fluid through a hydroelectric generator. Fluid discharging from the generator is captured in a recycling pool which in turn refills the shaft. The float tank is drained into a drain tank which in turn allows the float tank to ascend. The drain tank is recycled by first allowing it to descend over a plug, thus expelling its fluid back into the fluid chamber. The slidable plug then descends through the drain tank, drawing air back into the tank, whereby the drain tank and plug are enabled to ascend together. A plurality of valves control the flow of air and water in the system.

Additional features of the hydro engine include controlling the flow into the turbine intake and out of the recycling pool so that the float tank can be held in position during draining or filling with ballast.

In its open system form, a version consistent with the invention includes the aforementioned apparatus; however, the discharge from the generator may not be captured and the shaft may be refilled instead by another fluid source. Alternative uses for the open-system version include utilizing the shaft water pressure to elevate water or to transfer water across a distance.

The above and other objects and advantages of the present invention shall be made apparent from the accompanying drawings and the description thereof.

### BRIEF DESCRIPTION OF THE DRAWINGS

FIG. 1 is a cross-section view of a variable buoyancy float engine according to the principles of the present invention.

FIG. 2 is a partial cross-section view of the drain tank and plug shown in FIG. 1.

FIG. 3 is a partial cross-section view, similar to FIG. 2, of the drain tank and plug after the drain tank has received the drained fluid from the float tank.

FIG. 4 is a partial cross-section view, similar to FIGS. 2 and 3, of the drain tank and plug after the drain tank has descended.

FIG. 5 is a partial cross-section view, similar to FIG. 2-4, of the drain tank and plug after the plug has descended.

The accompanying drawings, which are incorporated in and constitute a part of this specification, illustrate embodiments of the invention and, together with a general description of the invention given above, and the detailed description of the embodiments given below, serve to explain the principles of the invention.

### DETAILED DESCRIPTION

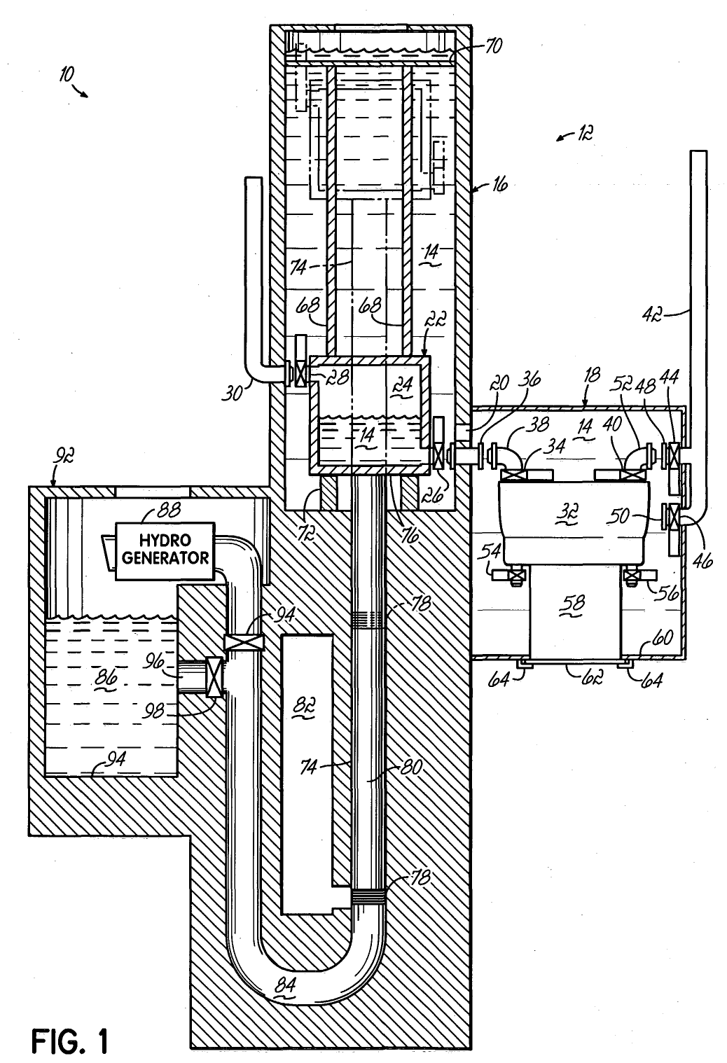

Referring to the figures and to FIG. 1 in particular, a variable buoyancy float engine or system for generating work 10 is shown. The system 10 includes a fluid chamber 12 that is filled with a stored fluid 14 such as water. The fluid chamber 12 has an upper reservoir 16 and a lower reservoir 18. The reservoirs 16, 18 are connected by a channel 20 which permits free flow of the fluid 14 between the two reservoirs 16, 18. While two distinct reservoirs 16, 18 are illustrated, in alternative embodiments, the fluid chamber 12 may be comprised of a single reservoir or a plurality of reservoirs.

Contained within the upper reservoir 16 is a float tank 22. The float tank 22 has an inner chamber 24 that can hold a fluid ballast 14 such as water. The float tank 22 has a water vent or drain valve 26 through which the fluid 14 can be let in as trapped air is released through an upper hatch or air vent valve 28. The air vent valve 28 is connected to a source of air, like the atmosphere, through a pipe 30 or other like conduit.

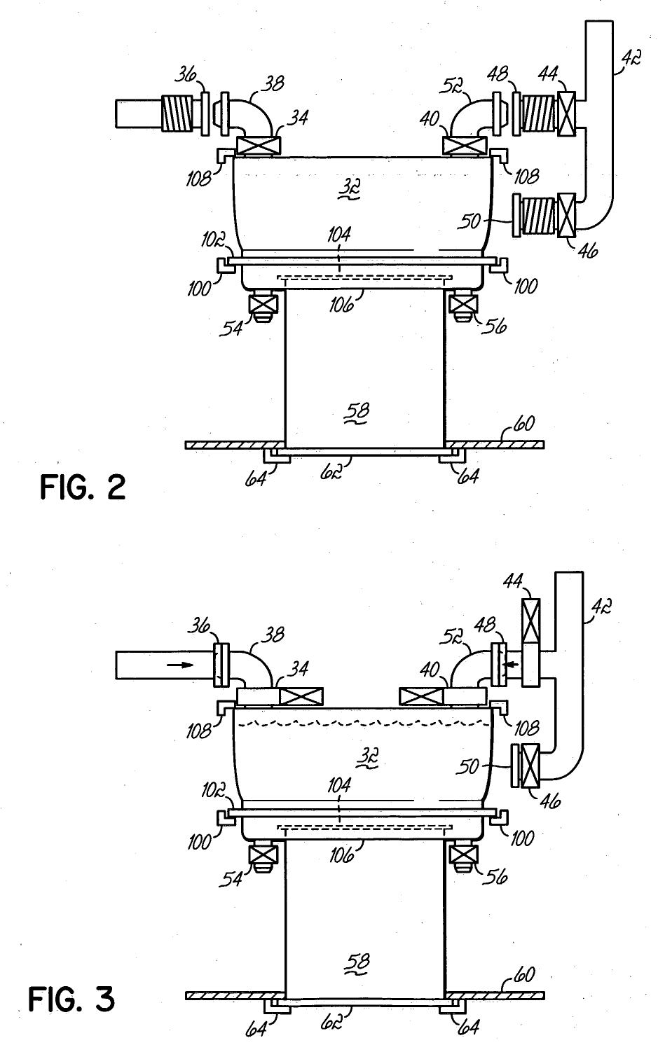

The system 10 also contains a drain tank 32 which is positioned in the lower reservoir 18 of the fluid chamber 12 so as to allow fluid 14 from the float tank 22 to gravitationally flow into the drain tank 32. A float tank drain receiver valve 34 attached to the drain tank 32 operationally connects with the float tank drain valve 26. As shown in FIG. 2, a retractable pipe 36 and an elbow pipe 38 can be used between the two valves 26, 34 to facilitate fluid 14 communication from the float tank 22 and the drain tank 32. The retractable pipe 36 could be an accordion pipe, a telescopic pipe, or any like pipe which allows for longitudinal expansion and retraction. However, in alternative embodiments the float tank 22 and the drain tank could be positioned so as to allow the two tanks 22, 32 to be directly coupled to each other, without the need for any retractable pipes. In addition, the movement of the float tank 22 and/or the drain tank 32 could be used to facilitate the mating and the operation of the valves 26, 34.

The drain tank 32 also contains an air vent valve 40. The air vent valve 40 is connected to a source of air, such as the atmosphere, via a pipe 42 or other like conduit. The air pipe 42 has an upper valve 44 and a lower valve 46. Here retractable pipes 48, 50 and an elbow pipe 52 can be used to facilitate the connection between the air vent valve 40 and the respective air pipe valves 44, 46. The retractable pipes 48, 50 could be accordion pipes, telescopic pipes, or any like pipes which allow for longitudinal expansion and retraction. However, in alternative embodiments the air vent valve 40 and the respective air pipe valves 44, 46 could be positioned so as to allow direct coupling, without the use of retractable pipes. In addition, the vertical movement of the drain tank 32 could be used to facilitate the mating and operation of the valves 40, 44, 46.

As shown, the drain tank 32 has a pair of drain tank equalizing valves 54, 56 which allow fluid to flow from the drain tank 32 into the lower reservoir 18. While two valves 54, 56 are shown, in alternative embodiments, any number may be used. Additionally, in alternative embodiments the float tank drain receiver valve 34 and/or the air vent valve 40 could function as equalizing valves.

A plug 58 is slidably connected within the drain tank 32. In operation, the drain tank 32 descends over the plug 58 and the plug 58 can descend below the floor or base 60 of the lower reservoir 18. The drain tank 32 has a seal ring (not shown) which prevents fluid from flowing between the drain tank 32 and the lower reservoir 18 at the area where the plug 58 contacts the drain tank 32. Similarly, the base 60 of the lower reservoir 18 also contains a seal ring (not shown) which prevent fluid 14 from escaping from the lower reservoir 18. The base or bottom 62 of the plug 58 is supported by at least one (two shown) mechanical plug stops 64.

One embodiment of the present invention includes a float tank guide 66 which constrains the float tank 22 to translate vertically in the upper reservoir 16. As shown, the float tank guide 66 is comprised of a pair of generally vertical guide posts 68, to which the float tank 22 slidably contacts or is connected, a float tank upper stop 70, and a float tank lower stop 72.

A discharge piston 74 is connected to the bottom 76 of the float tank 22. The opposite end of the piston 74 terminates in a discharge piston seal 78. The piston 74 fits and vertically translates within a discharge shaft 80. A piston ring access room 82 is provided to aid in maintaining the discharge piston ring 78 that would be expected to wear during operation.

In one embodiment, the piston 74 can be connected directly to a converter such as gear assembly, a pump like mechanical system (not shown) which is adapted to convert mechanical energy into work. Alternatively, the converter could be directly and operatively connected to the float tank 22.

As shown, the lower portion 84 of the shaft 80 contains a second fluid 86 such as water. While the first fluid 14 and the second fluid 86 may be the same, and will typically be water, the two bodies of fluid 14, 86 will typically not mix. In some embodiments, however, it may be advantageous to use fluids in the two fluid bodies 14, 86 with different buoyancy, viscosity, or corrosive properties.

A shown, the shaft 80 is connected to a convertor 88 in the form of a hydroelectric generator which has a turbine intake (not shown) and a turbine discharge (not shown). Any suitable generator, including induction type generators like a Pelton turbine, may be used. As shown, a generator valve 90 is interposed between the lower portion 84 of the shaft 80 and the generator 88. The generator valve 90 may be in the form of a vein valve. The second fluid 86 is forced through the generator 88 by the piston 74 and passes out of the turbine discharge and into a discharge or recycling pool 92.

The recycling pool 92 is typically positioned substantially lower than the upper reservoir 12 so that the base or bottom 94 of the recycling pool 92 and the feedback line 96 is vertically positioned at an elevation to permit an equal amount of the fluid 86 that was discharged into the recycling pool 92 from the generator 88 to be recycled back into the shaft 80. A recycling pool valve 98 is interposed between the recycling pool 92 and the shaft 80 and is adapted regulate the flow of the fluid 86 from the recycling pool 92 back into the shaft 80. The recycling pool valve 98 may be in the form of a vein valve. In alternative embodiments, the feedback line 96 could be shortened or even eliminated, allowing for the recycling pool valve 98 to directly connect the recycling pool 92 with the shaft 80.

The generator valve 90 and the recycling pool valve 98 can further-be used to regulate the vertical motion of the float tank 22. For example the generator valve 90 and the recycling pool valve 98 can be closed to prevent air or fluid from exiting the shaft 80. This will keep the float tank 22 from beginning to descend before it is filled with fluid 14. Thus, when the generator valve 90 is opened and the float tank 22 begins to descend, the filled float tank 22 will exert a sufficient pressure on the piston 74 for efficient operation of the hydroelectric generator 88. Similarly, when the float tank 22 is at its lower position, the generator valve 90 and the recycling pool valve 98 can again remain closed to keep the float tank 22 at its lower position until the fluid 14 is drained into the drain tank 32. At that point, the recycling pool valve 98 can be opened, allowing the now buoyant float tank 22 to ascend.

In operation, the system 10 begins with the upper reservoir 16 being filled with fluid 14, and the inner chamber of the float tank 22 and the drain tank 32 substantially empty of fluid 14. The float tank 22 is thus positively buoyant and positioned at or near its upper limit near the top of the upper reservoir 16. The trapped air in the inner chamber 24 offsets the weight of the empty float tank 22.

The water vent 26 is opened to allow fluid 14 to be taken into the inner chamber 24 of the float tank 22 as air trapped within the inner chamber 24 is released through the upper air hatch 28. Once the float tank 22 is filled with fluid 14, the generator valve 90 is opened and the now negatively buoyant float tank 22 is allowed to descend. In some embodiments, other mechanical stops or braces may also need to be released to allow the float tank 22 to begin its descent. As the negatively buoyant float tank 22 descends, its weight is transferred through the discharge piston 74 into pressurizing the fluid in the shaft 80. The discharge piston seal 78 prevents this pressurized fluid in the shaft 80 from bypassing back into the upper reservoir 16. The pressurized fluid 86, unable to go directly into the recycling pool 92 because the recycling pool valve 98 is closed, goes through the generator valve 90 and into the turbine intake of the hydroelectric generator 88.

Once the float tank 22 reaches its lower limit in the upper reservoir 16, the generator valve 90 is closed to keep the float tank 22 at its lower position while it drains it fluid 14 into the drain tank 32. As shown in FIG. 3, a pipe 36 is extended to connect the float tank drain valve 26 (FIG. 1) with the float tank drain receiver valve 34 which is connected to the drain tank 32. Alternatively, the two valves 26, 34 could be directly coupled. The air vent 28 in the float tank 22 is also connected and opened to an air supply pipe 30 which permits the fluid 14 in the float tank 22 to gravitationally flow into the drain tank 32. After the float tank 22 has drained, the float tank drain valve 26 is closed and the recycling pool valve 98 is opened, allowing the float tank 22 to ascend.

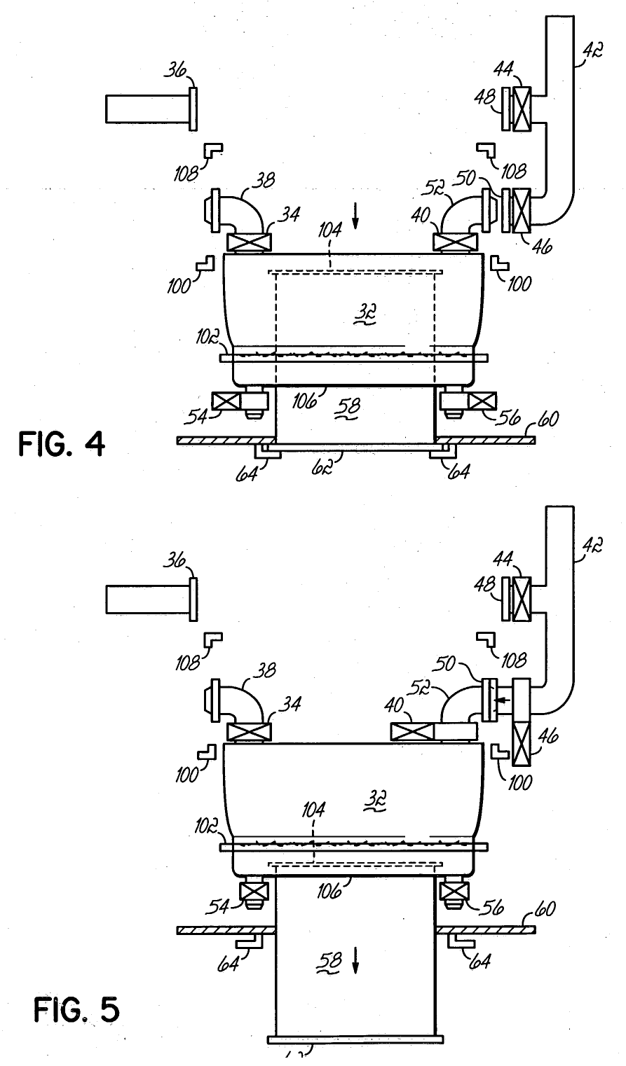

While the float tank 22 is ascending, as shown in FIG. 4, the drain tank equalizing valves 54, 56 are opened and the mechanical stops 100 are disengaged from the drain tank support member 102 allowing the drain tank 32 to gravitationally descend over the plug 58. The drain tank 32 will descend to a point at or near the top 104 of the plug 58 and may in alternative embodiments be supported by the plug 58, by the bottom 60 of the lower reservoir 18, or by another mechanical stop (not shown).

Next, as shown in FIG. 5, the drain tank air valve 40 is connected and opened to the air supply pipe 42 via the lower air supply valve 46. Once the air connection is established, the mechanical plug stops 64 holding the plug 58 are released and the plug 58 is allowed to gravitationally descend. The plug 58 will descend to a point where its top 104 is at or near the bottom 106 of the drain tank 32. As the plug 58 descends, air is drawn into the drain tank 32 and it becomes buoyant. The drain tank 32 may be kept in place by means of other mechanical stops (not shown) until it is filled with air. The air valve 40 is then closed and the drain tank 32 along with the plug 58 buoyantly ascend back to their starting positions. A set of upper mechanical stops 108 may be used to position the drain tank 32 in its proper position.

This closed system 10 lends itself to a number of variations. For example, an upper reservoir vent cap (not shown) and recycling pool vent cap (not shown) could be use to maintain atmospheric pressure within each containment chamber while also providing protection from the elements. In addition, the upper reservoir 12 could be filled from an available water supply at a higher elevation, thus allowing gravity feed with the corresponding energy savings. Also, the float tank 22 could be structurally held during draining or filling rather than relying on the pressure of suction in the shaft 80. Moreover, some applications could omit the holding of the float tank 22 at its upper or lower limit during transitions. Also, more than one float tank 22 may be able to feed a single generator 88 and discharge into a single drain tank 32, allowing for a nearly constant motive fluid flow to be provided to the hydroelectric generator 88, thus allowing for continuous generation of power.

Another embodiment of the present invention provides for a float actuated hydroelectric generator open system. In one implementation, there is not a need for a drain tank 32 but rather the float tank 22 can be drained directly to a destination outside of the fluid chamber 12. A fluid source (not shown) refills the upper reservoir 16. The operation of the float tank 22 with its discharge piston 74 and piston seal 78 within the shaft 80 is as described above.

Similarly, another embodiment of the present invention provides for a separate fluid replenishment source for refilling the shaft 80. The fluid replenishment source could be closed during descent of the float tank 22 by an interposed replenishment valve (not shown). In yet another variation, the fluid replenishment source could also be a source for refilling the upper reservoir 16.

Another embodiment consistent with the principles of the present invention would be to use the hydro engine system 10 as a large volume water pump to transfer water through an aqueduct for irrigation. In this application, instead of a generator, a one-way valve allowing the hydro engine to pulse streams of water is used.

The advantage of these versions and other versions consistent with the invention is that during descent of the float tank 22, the motive force of fluid 86 passing through the hydroelectric generator 88 can be increased, allowing efficient operation. Also, the storing of fluid, such as water, in an upper reservoir minimizes the need for ecologically unsound dams.

Although ground water is assumed to be the most plentiful and practical fluid for practicing the hydro engine invention, obviously many other fluids could be substituted. For example, operation of the hydro engine in sub-freezing temperatures may require mixtures that would remain liquid. Corrosion of materials may be of consideration. In addition, versions consistent with this invention could utilize manufacturing effluents, consumer waste water, or nuclear power plant cooling water, etc.

The hydro engine lends itself to augmenting an existing hydroelectric facility. Given constraints on the amount of water that can be drained from behind the hydroelectric dam, the hydro engine could fulfill a way of continuing to provide pressurized water to the generators.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

1. A system for producing work comprising:
a fluid chamber adapted to hold a first fluid;
a float tank positioned within the fluid chamber, the float tank adapted to receive the first fluid from the fluid chamber, the float tank having variable buoyancy allowing descent to a lower position and ascent to a higher position within the float chamber;
a convertor for converting mechanical energy into work operatively connected to the float tank;
a drain tank vertically positioned in the fluid chamber near the lower position of the descent of the float tank in the fluid chamber, the drain tank adapted to gravitationally receive the first fluid from the float tank;
a plug slidably connected within the drain tank, the plug adapted to remain stationary as the drain tank gravitationally descends around the plug, the plug adapted to gravitationally descend through the drain tank as the drain tank remains stationary; and
wherein as the drain tank gravitationally descends around the plug the first fluid in the drain tank flows into the fluid chamber, and wherein as the plug gravitationally descends through the drain tank air is drawn into the drain tank permitting the drain tank and the plug to buoyantly ascend.

2. The system of claim 1 wherein the float tank comprises:
an inner chamber for holding the first fluid and air;
a drain valve to allow fluid communication with the inner chamber; and
an air vent valve to expel air as the first fluid flows into the inner chamber and to draw air in when the first fluid flows out of the inner chamber.

3. The system of claim 2 further comprising:
a float tank drain receiver valve attached to the drain tank and operatively connected to the drain valve of the float tank;
an air vent valve attached to the drain tank; and
an air pipe having an upper vent valve and a lower vent valve, the air pipe positioned so as to enable the air vent valve attached to the drain tank to operatively couple with the upper vent valve when the drain tank is ascended and to operatively couple with the lower vent valve when the drain tank is descended.

4. The system of claim 1 further comprising a plurality of the float tanks, the plurality of the float tanks vertically positioned at relatively staggered elevations whereby at least one float tank is always descending and whereby the convertor is continuously generating work.

5. The system of claim 1 further comprising a float tank guide connected to the float tank, the float tank guide constraining the float tank to translate vertically between the lower position and the higher position.

6. The system of claim 5 wherein the float tank guide comprises:
a generally vertical guide post slidably contacting the float tank;
a float tank upper stop to set the higher position of the float tank vertical movement; and
a float tank lower stop to set the lower position of the float tank vertical movement.

7. The system of claim 1 wherein the fluid chamber has an upper reservoir and a lower reservoir.

8. The system of claim 7 wherein the drain tank is positioned in the lower reservoir.

9. The system of claim 7 wherein the convertor is a generator.

10. The system of claim 9 further comprising:
a piston connected to the float tank;
a shaft adapted to allow the piston to vertically slide within at least a portion of the shaft, the shaft adapted to hold a second fluid, the shaft positioned between the float tank and the generator wherein the piston forces the second fluid to flow through the generator; and
a recycling pool positioned to receive the second fluid from the generator and recycle the second fluid back to the shaft.

11. The system of claim 10 wherein the recycling pool is positioned so as to allow for an equal amount of fluid that flowed through the generator to be recycled back to the shaft.

12. The system of claim 10 wherein the generator is a hydroelectric generator having a turbine intake and a turbine discharge whereby the second fluid passes out of the turbine discharge and into the recycling pool.

13. The system of claim 10 further comprising a generator valve interposed between the shaft and the generator, the generator valve adapted to prevent the float tank from descending until the float tank is filled with the first fluid.

14. The system of claim 10 further comprising a recycling pool valve interposed between the recycling pool and the shaft, the recycling pool valve configured to be open during ascent of the float tank whereby the piston draws the second fluid from the recycling pool back into the shaft.

15. The system of claim 14 wherein the recycling pool valve is configured to remain closed while the first fluid drains from the float tank whereby the float tank remains at the lower position while the float tank is being drained.

16. A system for producing electricity comprising:
a fluid chamber having an upper reservoir and a lower reservoir, the fluid chamber adapted to hold a first fluid;
a float tank positioned within the fluid chamber, the float tank having an inner chamber for holding the first fluid and air, a drain valve to allow the first fluid into and out of the inner chamber, the first fluid rendering the float tank negatively or positively buoyant with respect to the first fluid in the fluid chamber, and an air vent valve to expel air being replaced with the first fluid and to draw air in when the first fluid is expelled, whereby the float tank has a variable buoyancy allowing descent to a lower position and ascent to a higher position within the float chamber;
a float tank guide connected to the float tank, the float tank guide having a generally vertical guide post slidably contacting the float tank, a float tank upper stop to set the higher position of the float tank vertical movement, and a float tank lower stop to set the lower position of the float tank vertical movement, whereby the float tank is constrained to translate vertically between the lower position and the higher position;
a hydroelectric generator for converting mechanical energy into electricity operatively connected to the float tank, the generator having a turbine intake and a turbine discharge;
a piston connected to the float tank;
a shaft adapted to allow the piston to vertically slide within at least a portion of the shaft, the shaft adapted to hold a second fluid, the shaft positioned between the float tank and the generator whereby the piston forces the second fluid to flow through the generator;
a generator valve interposed between the shaft and the generator, the generator valve adapted to prevent the float tank from descending until the float tank is filled with the first fluid;
a recycling pool adapted to receive the second fluid from the turbine discharge of the generator and recycle the second fluid back to the shaft, the recycling pool positioned so as to allow for an equal amount of fluid that flowed through the generator to be recycled back to the shaft;
a recycling pool valve interposed between the recycling pool and the shaft, the recycling pool valve configured to be open during ascent of the float tank allowing the piston to draw the second fluid from the recycling pool into the shaft, the recycling pool valve configured to remain closed while the first fluid drains from the float tank whereby the float tank remains at the lower position while the float tank is being drained;
a drain tank vertically positioned in the lower reservoir of the fluid chamber near the lower position of the descent of the float tank in the fluid chamber, the drain tank adapted to gravitationally receive the first fluid from the float tank;
a plug slidably connected within the drain tank, the plug adapted to remain stationary as the drain tank gravitationally descends around the plug, the plug adapted to gravitationally descend within the drain tank as the drain tank remains stationary; and
wherein as the drain tank gravitationally descends around the plug the first fluid in the drain tank flows into the fluid chamber, and wherein as the plug gravitationally descends within the drain tank air is drawn into the drain tank permitting the drain tank and the plug to buoyantly ascend.

17. A system for generating electricity comprising:
a fluid source;
an upper reservoir for holding a stored fluid from the fluid source;
a shaft having a straight portion, the shaft vertically communicating with the upper reservoir;
a shaft one-way valve operably connected to the shaft, the shaft one-way valve configured to pass water to a discharge end of the shaft;
a fluid replenishment source operably connected to the shaft for refilling the discharge line;
a float tank having variable buoyancy allowing descent and ascent within the upper reservoir, the float tank having a piston with an outer diameter less than the inner diameter of the discharge shaft and vertically translating within the shaft to force the stored fluid through the shaft during descent.

18. The system of claim 17 further comprising a shaft replenishment inlet valve interposed between the fluid replenishment source and the shaft, the replenishment inlet valve configured to open during ascent of the float tank.

19. The system of claim 18 wherein the fluid replenishment source is communicatively coupled with the fluid source.

20. The system of claim 19 wherein the float tank has an inner chamber for accepting ballast through a water vent to become negatively buoyant with respect to the stored fluid in the upper reservoir, and the inner chamber drains the ballast to become positively buoyant with respect to the stored fluid in the upper reservoir, allowing the float tank to translate vertically.

21. The system of claim 18 wherein the shaft replenishment inlet valve is configured to remain closed during draining of the float tank whereby the float tank remains at the bottom of the upper reservoir during the entire draining.
